(19) United States
(12) Patent Application Publication
(10) Pub. No.: US 2004/0185900 A1
(43) Pub. Date: Sep. 23, 2004

(54) Cell phone with digital camera and smart buttons and methods for using the phones for security monitoring

(76) Inventor: William McElveen, Houston, TX (US)

Correspondence Address: ROBERT W STROZIER, P.L.L.C, PO BOX 429, BELLAIRE, TX, 77402-0429, US

(21) Appl. No.: 10/393,527

(22) Filed: Mar. 20, 2003

(51) Int. Cl. H04Q 7/20

(52) U.S. Cl. 455/556.1; 455/564; 455/466; 455/563

(57) ABSTRACT

A cell phone and cell phone monitoring system is disclosed, where the cell phone includes at least one hot button or voice executable command which instructs the phone to acquire digital image data from an associated digital camera and optionally other data and send the data to a pre-set number representing the monitoring system. The monitoring system then determines whether an emergency situation exists and takes appropriate measures. A method is also disclosed for contacting emergency services upon determination of an emergency situation.

### BACKGROUND OF THE INVENTION

1. Field of the Invention

The present invention relates to a cell phone including a digital camera and smart buttons and to method for using the phone for security monitoring and event chronicling.

More particularly, the present invention relates to a cell phone including a digital camera and at least one button designed to active the camera, capture an image and transmit the captured image to a monitoring system adapted to take appropriate actions depending on the circumstances of the transmission. The present invention also relates to a monitoring system adapted to receive audio and visual data from the cell phones of this invention and to act on the data depending on circumstances.

2. Description of the Related Art

Cell phones have become an integral part of modern day live and has security systems. However, to date no monitoring system has taken advantage of cell phones having digital cameras the vehicle for obtaining data and acting on the data.

Thus, there is a need in the art for cell phones designed with at least one hot button, which when activated takes and sends audio and visual data to a monitoring system adapted act on the data depending on circumstance.

### SUMMARY OF THE INVENTION

The present invention provides a cell phone including a digital camera and either at least one voice activated capture and send command or function or at least one hot button that activates a capture and send command or function when depressed, where the command or function automatically sends audio, visual, identification and optionally global positioning data to a preset telephone number.

The present invention also provides a monitoring system including a plurality of servers, preferably trusted servers, with sufficient call handling ability to receive data from a large number of cell phones of this invention and act on the data depending on circumstances, where the acts includes storing the data for later user retrieval when the circumstances evidence a non-emergency situation, contacting emergency personnel (police, fire, para-medics, etc.), when the circumstances evidence an emergency situation, or holding the data in temporary storage until sufficient data is acquired to determine whether the situation is an emergency situation or a non-emergency situation.

The present invention provides a cell phone including a digital camera and either a plurality of voice activated capture and send commands or functions or a plurality of hot buttons that activates a plurality of capture and send commands or functions when depressed, where the commands or functions send audio, visual, identification, command type and optionally global positioning data to a preset telephone number.

The present invention also provides a monitoring system including a plurality of servers, preferably trusted servers, with sufficient call handling ability to receive data from a large number of cell phones of this invention and act on the data depending on the button depressed or the voice command activated, where the acts includes storing the data for later user retrieval when a store hot button or voice command is activated indicating a non-emergency situation or contacting emergency personnel (police, fire, para-medics, etc.), when an emergency hot button or voice command is activated indicating an emergency situation or holding the data in temporary storage until sufficient data is acquired to determine whether the situation is an emergency situation or a non-emergency situation.

The present invention provides a method for monitoring data transmission from cell phones of this invention including the steps of activating an autosend function on a cell phone of this invention, capturing at least audio, visual, identification, optionally command type and optionally global positioning data, transmitting the data to a preset telephone number, and acting on the data depending on circumstances.

### DESCRIPTION OF THE DRAWINGS

The invention can be better understood with reference to the following detailed description together with the appended illustrative drawings in which like elements are numbered the same:

### DETAILED DESCRIPTION OF THE INVENTION

The inventors have found that a cell phone with a built digital camera can be modified to included at least one pre-programmed button, which when activated causes the phone to acquire a discrete image or to acquire a continuous image, connect to the pre-programmed number automatically, and upload the image file or stream and optionally upload audio to a monitoring service, where the monitoring service has the option of storing the data for later review, storing the data for later review and evaluating the data for potential contacting of emergency services or storing the data for later review and immediately contacting emergency services. The inventor has also found that a nation-wide monitoring system can be constructed using cell phones with built in digital cameras for storing, retrieving and notifying emergency services based on the content of visual or audiovisual data transmitted to the monitoring system when a pre-programmed button is activated on the phone.

The present invention broadly relates to a cell phone including a digital camera and a voice activated system capable of capturing a voice command and automatically executing a set of instructions and/or at least one hot button that when activated automatically causes execution of the set of instruction, where the instructions include at least the immediate capture and/or transmission, on a discrete, periodic or continuous basis, of visual data, identification data, optional audio data and optional positioning data to a pre-programmed telephone number.

The present invention also broadly relates to a monitoring system including a plurality of servers, preferably trusted servers, with sufficient call handling capability to receive data from a large number of cell phones of this invention and to act on the data depending on circumstances, where the acts includes storing the data for later user retrieval when the circumstances evidence a non-emergency situation or a non-emergency activation occurred, storing the data for later retrieval and contacting emergency personnel (police, fire, paramedics, etc.), when the circumstances evidence an emergency situation or an emergency activation occurred, or holding the data in temporary storage until sufficient data is acquired to determine whether the situation is an emergency situation or a non-emergency situation followed by permanent storage of the data.

The present invention broadly relates to a method for monitoring data transmission from cell phones of this invention including the steps of activating an auto-send function on a cell phone of this invention, capturing at least visual data, identification data, optional audio data, optional command type data and optional global positioning data, transmitting the data to a preset telephone number associated with a monitoring site, analyzing the data at the monitoring site, and acting on the data depending on data content and context.

The cell phones suitable for use in the present invention include, without limitation, any cell phone now manufacture or that will be manufactured in the future and includes a digital camera or other image capturing device and includes hot buttons for activation of an auto-capture and send function such phones that can be modified to include hot buttons and associated command processing software include phones manufactured by Motorola, Panasonic, ATT, Nextel, Verizon, Sprint, SBC, Sony, Siemens, Samsung, Qualcomm, Nokia, Ericsson, Alcatel, Uniden, Vtech, Alpha cellular, or similar manufacturers.

The servers suitable for in the present invention include, without limitation, any digital processing unit capable of handling broad band communications, large number of incoming phone calls, large databases, large monitoring services, large outgoing phone calls, and other server functions, such servers includes digital processing unites manufactured by Intel, Samsung, Sony, Apple, HP, Dell, IBM, NEC, or similar manufacturers. The servers preferably use windowing operating systems such as WINDOWS from MicroSoft, OS from APPLE, LINUX, UNIX, or any other windowing operating system. The term digital processing unit means an apparatus that includes a unit capable of processing information in binary, is connected to cache memory, ROM or RAM, is connected to needed or desired peripherals and is connected to mass storage devices. The servers also include communication hardware and software sufficient to support broad band intercommunications and to support incoming cell phone calls and outgoing cell phone either land line or cellular. The term large number means that the system is capable of handling over a hundred simultaneous calls, preferably over a thousand simultaneous calls, particularly, over ten thousand simultaneous calls, especially, and over a hundred thousand simultaneous calls. Of course, the system can be appropriately configured to handle any number of simultaneous calls even in the millions of simultaneous calls.

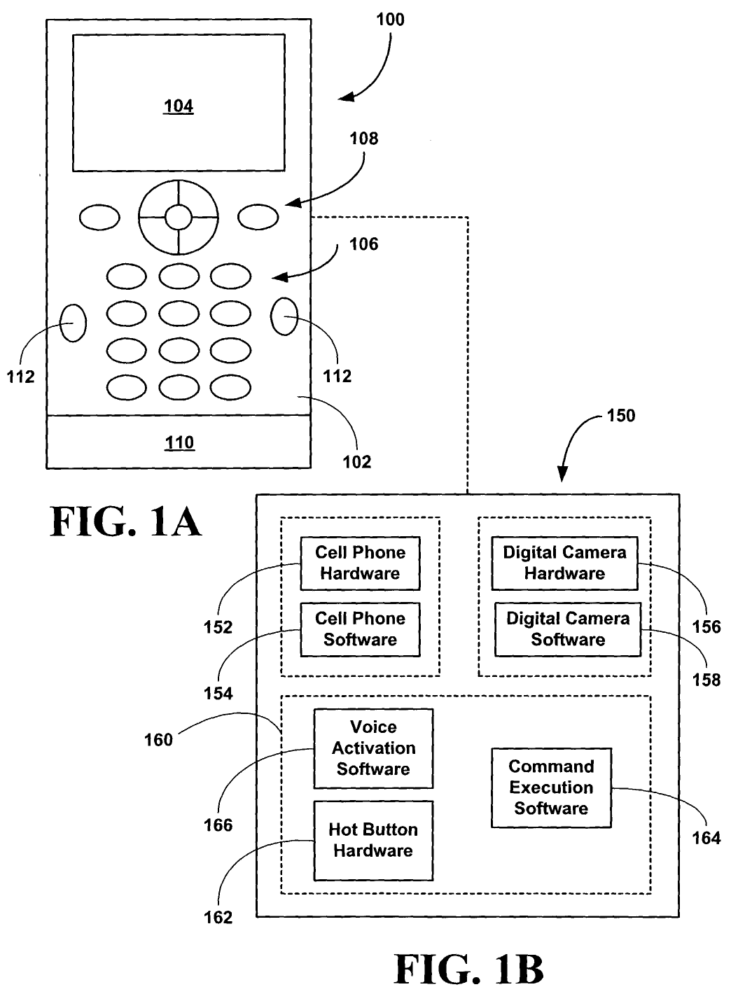

Referring now to FIG. 1A, a preferred embodiment of a cell phone of this invention, generally 100 is shown to include a housing 102, a display 104, dialing buttons 106, control buttons 108, a digital camera 110 and hot buttons 112. The hot buttons 112, when depressed, are integrated into the cell phone circuitry in such a way as to cause the cell phone to capture a digital image on a discrete, periodic or continuous basis, dial a pre-programmed phone number and transmit visual, identificational and optionally audio and positional data to the pre-programmed phone number. The pre-programmed phone number is associated with a monitoring site to be described in more detail below.

Referring now to FIG. 1B, a schematic diagram, generally 150, is shown depicing internal hardware and software requirements of the phone 100. The internal requirements 150 include cell phone hardware 152 and cell phone software 154, which preferably can be digital and/or analog. The cell phone hardware and software 152 and 154 include at least a receiver and transmitter, touch pad and processing unit, display hardware and software and other cell phone software and hardware features and aspects currently available on cell phones or features that will be introduced to cell phones in the future. See, e.g., U.S. Pat. Nos.: 6,522,893; 6,509,716; 6,505,055; 6,501,945; 6,491,194; 6,489,934; 6,484,040; 6,459,915; 6,454,146; 6,438,392; 6,434,372; 6,424,823; 6,418,323; 6,418,307; 6,408,186; 6,405,030; 6,400,965; 6,400,957; 6,398,019; 6,396,925; 6,389,115; 6,377,795; 6,377,686; 6,366,654; 6,364,184; 6,360,101; 6,353,747; 6,341,871; 6,327,466; 6,326,863; 6,321,097; 6,315,182; 6,314,365; 6,314,283; 6,313,698; 6,311,063; 6,308,086; 6,304,764; 6,304,748; 6,304,560; 6,304,233; 6,301,487; 6,292,665; 6,275,713; 6,271,865; 6,268,709; 6,266,543; 6,254,249; 6,246,688; 6,244,894; 6,243,596; 6,240,302; 6,240,277; 6,233,320; 6,222,458; 6,215,445; 6,212,377; 6,198,930; 6,198,823; 6,189,755;6,183,299; 6,182,878; 6,175,747; 6,167,287; 6,167,251; 6,163,709; 6,157,841; 6,154,664; 6,151,509; 6,150,985; 6,150,898; 6,150,890; 6,141,545; 6,132,897; 6,130,945; 6,125,271; 6,123,127; 6,115,604; 6,115,597; 6,088,584; 6,087,994; 6,082,535; 6,081,695; 6,075,977; 6,070,066; 6,067,358; 6,062,518; 6,049,723; 6,035,221; 6,035,217; 6,016,349; 6,014,559; 6,009,325; 6,009,320; 6,006,109; 6,006,087; 5,995,843; 5,995,824; 5,991,405; 5,988,450; 5,987,324;5,987,310; 5,977,747; 5,974,333; 5,971,557; 5,970,127; 5,969,688; 5,939,860; 5,938,137; 5,933,775; 5,933,496; 5,926,756; 5,903,135; 5,898,932; 5,870,615; 5,864,755; 5,836,496; 5,835,858; 5,833,100; 5,826,185; 5,796,338; 5,787,361; 5,761,624; 5,745,565; 5,729,591; 5,711,013; 5,711,012; 5,699,407; 5,675,630; 5,673,307; 5,673,306; 5,669,061; 5,655,004; 5,653,336; 5,642,404; 5,642,378; 5,606,608; 5,584,052; 5,555,286; 5,539,417; 5,517,683; 5,515,419; 5,511,704; 5,511,110; 5,471,530; 5,457,737; 5,446,783; 5,423,083; 5,396,556; 5,373,304; 5,367,309; 5,325,418; 5,230,173; 4,993,244; 4,878,237; 4,734,928; 4,677,653; and 4,661,659, incorporated herein by reference. The requirements 150 also include digital camera hardware 156 and software 158. Besides features present in existing cell phone or future cell phones, the cell phones of this invention also include automatic c apture and s end software 160. The automatic capture and send software 160 includes hot button hardware 162 and associated command execution software 164 and optionally voice activation software 166. When a hot button 112 is depressed, the button 112 activates the command execution software 164, which turns on the camera 110, calls a pre-programmed phone number associated with a monitoring site and transmits camera data to the monitoring site. Along with the visual data, the software can send cell phone identification data and optionally sends audio data and positional data if the phone includes GPS hardware or the cell location if the cell network is equipped with cell location utilities. If the phone 100 includes voice activation software 166, then when a pre-programmed word or phrase is uttered by the user, the command execution software 164 turns on the camera 110, calls a pre-programmed phone number associated with a monitoring site and transmits camera data to the monitoring site and optionally other data as described above.

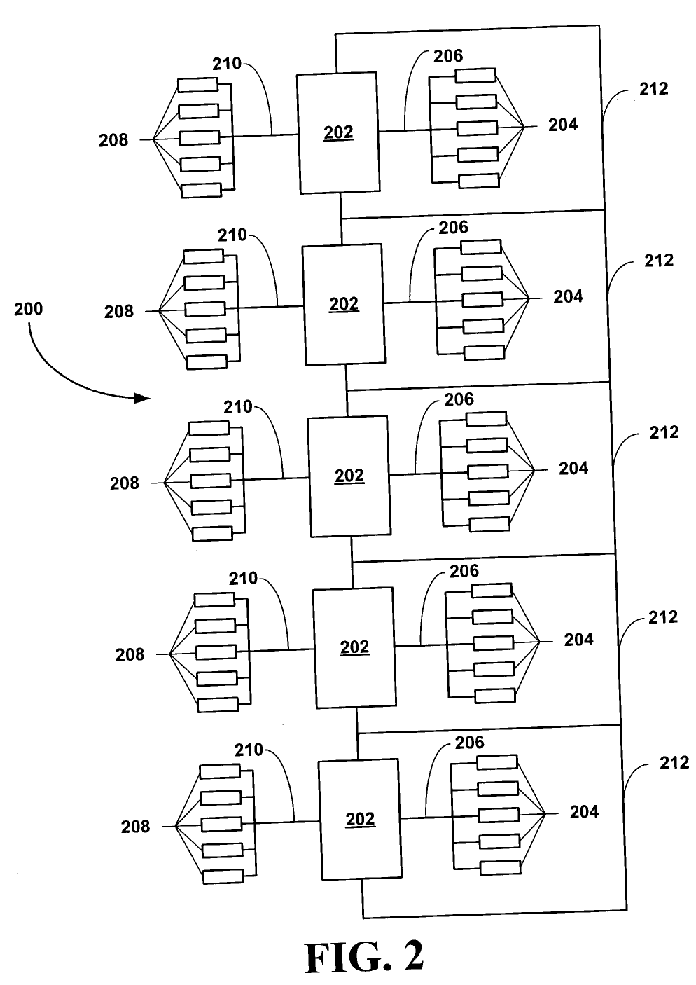

Referring now to FIG. 2, a schematic diagram of a preferred monitoring system of this invention, generally 200 is shown to include a plurality of servers 202, preferably the servers 202 are trusted servers. Each server 202 is capable of receiving data from and sending data to a plurality of cell phones 204 via phone links 206, where each cell phone 204 has the function of the cell phone described in FIGS. 1A-B. Each server 202 is in two-way communication with a plurality of monitors 208 via monitor links 210. The monitors 208 have the task of reviewing data from cell phones 204 and to determine whether an emergency situation exists, and if an emergency situation exists to contact the appropriate authorities such as police, EMS, fire, FBI, etc. The servers 202 are in two-way communication via server links 212 with each other. Although the servers links 212 shown in FIG. 2 from a closed ring, an ordinary artisan should recognize that the communication links 212 between the servers 202 can be any two-way communication link such as via an internet (the world wide web), via an intranet (direct land line interconnection of the servers), via a satellite intranet, other two-way communication formats or mixtures or combinations thereof.

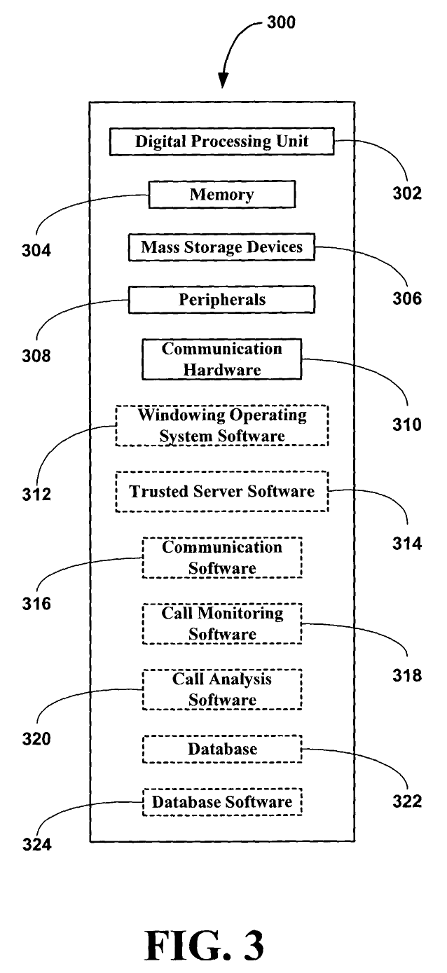

Referring now to FIG. 3, a schematic diagram of hardware and software features of a preferred server, generally 300, is shown to include a digital processing unit 302 and associated memory 304. The digital processing unit 302 can be any processing unit capable of executing digital instruction sets and includes, without limitation, chips manufactured by Motorola, Intel, HP, IBM, AMD, Cirex, Sun Microsystem, Samsung, NEC, NRC, Applied Materials, Erissen or any other chip manufacture or mixtures or combinations thereof. The memory 304 can include RAM, ROM, firm ware, any other memory construct or mixture or combinations thereof. The servers 300 also include mass storage devices 306, peripherals 308 and communication hardware 310. The mass storage devices 306 can include, without limitation, internal or external disk drives, internal or external CDROM drives (read only or read/write), internal or external solid state storage devices, computers, servers, any other internal or external storage device or mixtures or combinations thereof. The peripherals 308 include, without limitation, monitors, printers, scanners, mouses, any other peripheral or mixtures or combinations thereof. The communication hardware 310 can comprise any high speed, high band width communication hardware such as ethernet, token ring, any other high speed, high band width communication hardware or mixtures or combinations thereof.

The servers 300 also include a windowing operating system software 312, which can be any windowing operating system such as WINDOWS, Linux, UNIX, or the like, communication software 314 associated with the particular communication hardware used, and optionally trusted server software 316 such as those described in U.S. Pat. Nos.: 6,351,816; 6,330,610; 6,330,588; 6,289,462; 6,279,112; 6,263,442; 6,199,113; 6,134,550; 6,088,797; 6,081,899; 5,935,248; 5,745,886; 5,703,949; 5,619,657 and 5,557,518, incorporated hereinbyreference. The servers 300 also include call monitoring software 318, call analysis software 320, database software 322 and a database 324 for storing data from a cell phone received transmission.

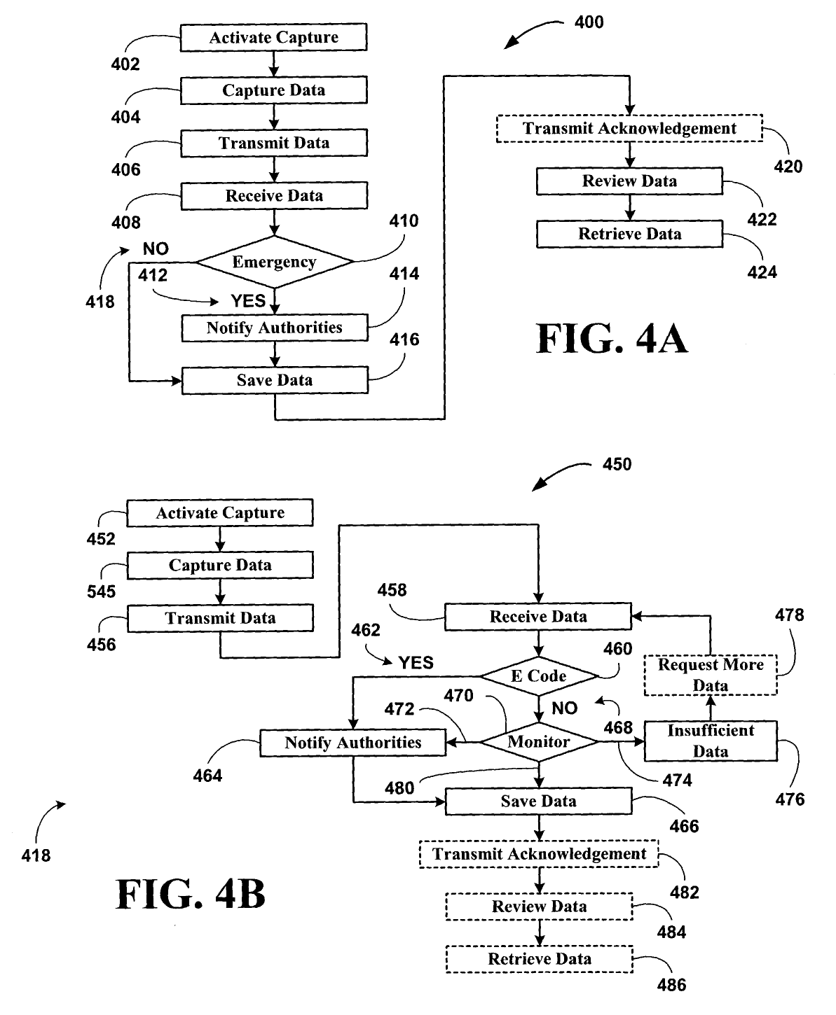

Referring now to FIG. 4A, a conceptual flowchart of a preferred call monitoring method and software, generally 400, is shown to include a cell phone activate capture event 402. The event 402 causes data to be captured by its associated cell phone in a data capture step 404. Once the data capture 404 is activated, the data is transmitted to the monitoring service in a transmit data step 406. After transmission, the data is received at the monitoring service in a receive step 408. Once received, the data is tested to determine whether the data includes an emergency situation indicator in a conditional emergency test step 410. If an emergency exists, then control is transferred along a YES branch 412 to a notify authorities step 414. The notify authorities step 414 is capable of determining the type of emergency from the information in the data and contracts the appropriate authorities such as police, fire, EMS, or the like, where police notification is the default. After notification, the data from the transmission is saved in a data save step 416. If the no emergency code is transmitted with the data, then control is transferred along a NO branch 418 to the save data step 416. After data storage, the software can optionally forward an acknowledgment to the cell phone user in a transmit acknowledgment step 420. The software 400 also includes the ability to review any saved data in a review data step 422 and to retrieve any saved data in a retrieve data step 424.

Referring now to FIG. 4B, a conceptual flowchart of another preferred call monitoring method and software, generally 450, is shown to include a cell phone activate capture event 452. The event 452 causes data to be captured by its associated cell phone in a data capture step 454. Once the data capture 454 is activated, the data is transmitted to the monitoring service in a transmit data step 456. After transmission, the data is received at the monitoring service in a receive step 458. Once received, the data is tested to determine whether the data includes an emergency situation indicator in a conditional E code test step 460. If an emergency exists, then control is transferred along a YES branch 462 to a notify authorities step 464. The notify authorities step 464 is capable of determining the type of emergency from the information in the data and contracts the appropriate authorities such as police, fire, EMS, or the like, where police notification is the default. After notification, the data from the transmission is saved in a data save step 466. If the no emergency code is transmitted with the data, then control is transferred along a NO branch 468 to a monitor test step 470, where either intelligent software monitors the data for indicia of an emergency condition or a human monitor reviews the data for indicia of an emergency condition. If an emergency condition is determined to exist upon data review, then control is transferred along a path 472 of the notify authorities step 464. If insufficient data has been received to make a determination of an emergency condition, then control is transferred along a path 474 to an insufficient data flag step 476 and back to the receive step 458 to await additional data. Optionally, a request for additional information can be forwarded to the cell phone as a call or as a silent command activating the capture feature of the phone in a request more data step 478. If no emergency is determined to exist, then control is transferred along a path 480 to the save data step 466. After data storage, the software can optionally forward an acknowledgment to the cell phone user in a transmit acknowledgment step 482. The software/method 450 can also include the ability to review any saved data in a review data step 484 and to retrieve any saved data in a retrieve data step 486.

All references cited herein are incorporated by reference. While this invention has been described fully and completely, it should be understood that, within the scope of the appended claims, the invention may be practiced otherwise than as specifically described. Although the invention has been disclosed with reference to its preferred embodiments, from reading this description those of skill in the art may appreciate changes and modification that maybe made which do not depart from the scope and spirit of the invention as described above and claimed hereafter.

We claim:

1. A cell phone apparatus including a digital camera and a voice or hot button activated function, where the function sends data to the preset telephone number.

2. The apparatus of claim 1, wherein the function further activates the digital camera, dials the preset telephone number and sends the data to the preset telephone number, where the data comprises visual data from the digital camera.

3. The apparatus of claim 2, wherein the function further sends contemporaneous audio and identification data to the preset telephone number.

4. The apparatus of claim 2, wherein the function further sends contemporaneous audio, identification and global positioning data to a preset telephone number.

5. The apparatus of claim 1, further including two voice or hot button activated functions, where one function sends an emergency code to the and another function includes a non-emergency code.

6. The apparatus of claim 5, wherein the functions further activate the digital camera, dials the preset telephone number and sends the data to the preset telephone number, where the data comprises visual data from the digital camera.

7. The apparatus of claim 6, wherein either function further sends contemporaneous audio and identification data to the preset telephone number.

8. The apparatus of claim 6, wherein either function further sends contemporaneous audio, identification and global positioning data to a preset telephone number.

9. A monitoring system including a plurality of servers including sufficient call handling capabilities to receive data from a plurality of cell phones of claims 1-8 and to act on the received data depending on circumstances, where the acts include storing the data for later user retrieval when the circumstances evidence a non-emergency situation, contacting appropriate emergency personnel, when the circumstances evidence an emergency situation, or holding the data in temporary storage until sufficient data is acquired to determine whether the situation is an emergency situation or a non-emergency situation.

10. The system of claim 9, wherein the data includes an emergency or non-emergency code and the system stores the data when the data includes the non-emergency code and contacts appropriate emergency personnel when the data includes the emergency code.

11. The system of claim 9, wherein the servers are trusted servers.

12. The system of claim 9, wherein the servers are distributed with each server servicing a specific geographical area.

13. The system of claim 12, wherein each server is designed to handle over a hundred simultaneous data transmissions from cell phones of claims 1-8.

14. The system of claim 12, wherein each server is designed to handle over a thousand simultaneous data transmissions from cell phones of claims 1-8.

15. A method for monitoring data transmission from a cell phone of claims 1-8 comprising the steps of:
activating an autosend function on the cell phone,
dialing a preset telephone number, and
transmitting data to a preset telephone number.

16. The method of claim 15, further comprising the step of:
acting on a contents of the data depending on circumstances.

17. The method of claim 16, wherein the function further activates the digital camera, dials the preset telephone number and sends the data to the preset telephone number, where the data comprises visual data from the digital camera.

18. The method of claim 17, wherein the function further sends contemporaneous audio and identification data to the preset telephone number.

19. The method of claim 17, wherein the function further sends contemporaneous audio, identification and global positioning data to a preset telephone number.

20. The method of claim 16, further including two voice or hot button activated functions, where one function sends an emergency code to the and another function includes a non-emergency code.

21. The method of claim 20, wherein the functions further activate the digital camera, dials the preset telephone number and sends the data to the preset telephone number, where the data comprises visual data from the digital camera.

22. The method of claim 21, wherein either function further sends contemporaneous audio and identification data to the preset telephone number.

23. The method of claim 21, wherein either function further sends contemporaneous audio, identification and global positioning data to a preset telephone number.
